(19) United States
(12) Patent Application Publication
(10) Pub. No.: US 2016/0346806 A1
(43) Pub. Date: Dec. 1, 2016

(54) Coating device and method for coating an outer surface of an item to be coated

(71) Applicant: Hinterkopf GmbH, Eislingen (DE)

(72) Inventors: Joachim SCHULZ, Deggingen (DE); Joachim WEBER, Bad Ditzenbach (DE)

(21) Appl. No.: 15/142,633

(22) Filed: Apr. 29, 2016

(30) Foreign Application Priority Data
Apr. 30, 2015 (EP) 15165965.3

(51) Int. Cl. B05D 1/02; B05B 13/02

(52) U.S. Cl. CPC B05D 1/02; B05B 13/0221

(57) ABSTRACT

Coating device for coating an outer surface of an item to be coated, having a discharge means for providing a continuous or discontinuous flow of coating and having a receiving means for receiving and positioning an item to be coated opposite the discharge means, wherein the discharge means comprises a discharge nozzle and a coating conveying means which is connected in a fluidically communicating manner to the discharge nozzle and is configured for a pressurised conveying of coating to the discharge nozzle, wherein it is provided that the coating conveying means (38) is configured to provide a hydrostatic pressure on the coating and that the discharge nozzles are configured to discharge threads of coating subject to the hydrostatic pressure on the coating.

### FIELD OF THE INVENTION

The invention relates to a coating device for coating an outer surface of an item to be coated, having a discharge means for providing a continuous or discontinuous flow of coating and comprising a receiving means for receiving and positioning an item to be coated opposite the discharge means, the discharge means comprising a discharge nozzle and a coating conveying means which is connected in a fluidically communicating manner to the discharge nozzle and which is configured for a pressurised conveying of coating to the discharge nozzle. The invention also relates to a method for coating an outer surface of an item to be coated.

### BACKGROUND

According to a non-documented prior art which is known to the Applicant, to coat an item to be coated which can be in particular a blank of an aerosol can having a substantially cylindrically barrel-shaped outer surface, an application of coating to the preferably previously printed outer surface by means of a roller arrangement is provided. By means of the roller arrangement, a coating is initially applied from a reservoir to a plurality of rollers oriented parallel to one another, with adjacent rollers rolling off one another, thereby achieving a homogenisation of coating film. Finally, one application roller is in direct contact with the outer surface of the item to be coated and while in contact therewith, it applies the coating to the outer surface.

### SUMMARY

The object of the invention is to provide a coating device and a method for coating an outer surface of an item to be coated, in which a compact construction method of the coating device and a contactless coating application to the item to be coated is ensured and which device and method can be operated and implemented in a small, self-contained spatial volume without an undesirable coating mist being produced.

This object is achieved for a coating device of the type mentioned at the outset which has the features of Claim 1. Here, it is provided that the coating conveying means is configured to provide a hydrostatic pressure on the coating and that the discharge nozzles are configured to discharge threads of coating at least mainly, in particular exclusively subject to hydrostatic pressure on the coating. This configuration of the coating conveying means and of the discharge nozzles ensures that the coating can be applied in a controlled and contactless manner to the outer surface of the item to be coated as threads of coating, i.e. as a compact strand without a misting of coating particles. In particular, no additional fluid, for example compressed air, is required to convey the coating from a reservoir to the discharge nozzle or nozzles. The discharge procedure for the threads of coating essentially depends on the hydrostatic pressure which is applied by the coating conveying means to the coating, on the viscosity of the coating which is predetermined for most coatings and can be adjusted within a particular range by a suitable temperature control procedure, on the shape of the discharge nozzle and on the distance between an opening in the discharge nozzle and the item to be coated.

It is particularly advantageous if the coating can be dis-charged from the discharge nozzle without electrostatic or electrodynamic influences on the coating, so that the coating does not have to have any particular characteristics in this respect, such as a predeterminable electrical conductivity. It is preferably provided that for the build-up of a hydrostatic pressure on the coating, either a reservoir is pressurised with compressed air or the coating is conveyed to the discharge nozzles by a pump means. The pump means is preferably arranged away from the discharge nozzles and is configured in particular as a coating feed pump. Furthermore, it is provided according to the invention that the discharge nozzles are configured geometrically so that the pressurised coating issues in the form of a thread from the discharge nozzle without an additional conveying fluid, in particular compressed air, and can be applied to the outer surface of the item to be coated which is arranged opposite thereto. It is preferably provided that the discharge nozzles are arranged with respect to the receiving means such that the issuing threads of coating are applied obliquely downwards or vertically downwards to the outer surface of the item to be coated. By a suitable choice of the shape of the discharge nozzles and of the hydrostatic pressure on the coating which is provided by the coating conveying means, at least for short distances between the item to be coated and discharge nozzle any desired spatial orientation of the discharge nozzles can be provided so that the issuing threads of coating can also be applied obliquely upwards or vertically upwards to the outer surface of the item to be coated. In the coating method, a distance is always provided between the discharge means and the item to be coated, so that this is a contactless coating method. A coating method of this type has the particular advantage that when a coating is applied to the item to be coated, a spray mist is not produced, as occurs in compressed air spray systems.

Advantageous developments of the invention are the subject of the subclaims.

It is expedient if the receiving means is configured for a rotational mounting of the item to be coated about an axis of rotation which is oriented transversely to a nozzle axis which determines a coating discharge direction from the discharge nozzle. With such an orientation of the receiving means and of the item to be coated which is to be received thereon with respect to the at least one discharge nozzle, an advantageous coating application to the item to be coated vertically/normally and thereby parallel to a surface normal of the outer surface of the item to be coated is ensured. Furthermore, a relative movement between item to be coated and discharge nozzle can be achieved by means of the rotational mounting for the item to be coated about the rotational axis. It is thereby possible for the item to be coated, configured by way of example as a cylindrical sleeve, to be efficiently covered with coating over its entire outer surface which at least substantially corresponds to a cylindrical barrel surface. It is particularly advantageous if a cross section of the item to be coated is circular and if the receiving means is arranged with its rotational axis with respect to the discharge nozzle in such a way that when the item to be coated rotates about the rotational axis, there is always at least substantially the same distance between item to be coated and discharge nozzle. The discharge nozzle is configured by way of example as a circular cylindrical hole in a nozzle plate, an axis of the hole being identical to the nozzle axis. Furthermore, it can be provided by way of example that the nozzle axis is oriented normally on an end face of the nozzle plate. It is particularly advantageous if only discharge nozzles, and no fluid discharge nozzles which influence the discharge of coating, in particular if absolutely no fluid discharge nozzles for a pressurised additional fluid, in particular compressed air are arranged in the nozzle plate.

In an advantageous development of the invention, it is provided that the discharge means is arranged in a linearly movable manner with respect to the receiving means and it comprises an adjusting means, which can be activated in an open loop or closed loop manner, for a linear movement along the rotational axis. As a result, during the coating procedure, two relative movements can be superimposed, thereby allowing coating to be applied over the complete outer surface of the item to be coated. The first relative movement between item to be coated and discharge nozzle is produced by the rotational movement of the receiving means about the rotational axis. The second relative movement between item to be coated and discharge nozzle occurs due to the linear movement of the discharge means along the rotational axis. Accordingly, a thread of coating, dis-charged in a continuous or discontinuous manner can be deposited by the discharge nozzle in a spiral shape or in another manner on the outer surface of the item to be coated. The adjusting means can be a fluidic drive or an electrical drive, for example a pneumatic cylinder or an electrical spindle drive which is controlled by a suitable control means.

It is preferably provided that a plurality of discharge means is arranged in a circulatory manner with respect to the rotational axis. In this respect, the discharge means can be arranged offset along the rotational axis to allow discharge nozzles to be arranged with respect to the item to be coated so that a complete coating or a coating which is provided at least in a predeterminable region is made possi-ble with as few revolutions as possible of the item to be coated about the rotational axis. It is provided by way of example that one or more of the discharge means are arranged in a linearly movable manner with respect to the receiving means and at least two discharge means can be moved synchronously or independently of one another along the rotational axis. It is preferably provided that nozzle axes of adjacently arranged discharge devices include an acute angle, in particular an angle of less than 45 degrees, thereby allowing a particularly compact arrangement of the discharge means.

In a further embodiment of the invention, it is provided that the discharge means comprises a plurality of discharge nozzles which are arranged in particular along a straight line oriented parallel to the rotational axis and are preferably arranged in a uniformly distributed manner. The discharge nozzles are preferably arranged in a uniform spacing relative to one another in which the threads of coating impacting the outer surface of the item to be coated come reliably into contact with adjacently applied threads of coating so that a closed coating surface can be created.

In a further embodiment of the invention, it is provided that a valve device for a temporary interruption in the fluidically communicating connection is arranged between the coating conveying means and the discharge nozzle. By means of the valve device which is preferably an electromechanical valve, in particular a magnetic valve, the flow of coating can be influenced in a highly dynamic manner between the coating conveying means and the discharge nozzle. It is preferably provided that the valve device is arranged directly upstream of the discharge nozzle so that a volume of coating which cannot be influenced by the switch position or control position of the valve device is minimised as far as possible. This measure reduces an undesirable drip formation in the surroundings of the discharge nozzle. For example, the valve device can be configured as a needle valve which engages by a valve needle into a valve seat directly formed in the discharge nozzle, in a transition from a coating conveying channel, which can be called a valve chamber, to the discharge nozzle and thereby minimises as far as possible the volume of coating which cannot be in-fluenced.

It is advantageous if a temperature-control means is arranged with the coating conveying means and/or with the discharge means and/or with the receiving means, in particular a heating means, to control the temperature of the coating and/or of the item to be coated. Since the coating is applied as threads of coating to the outer surface of the item to be coated, it is advantageous if the thread of coating is very flowable when it impacts the outer surface in order to wet the greatest possible surface area of the outer surface with coating. For this it is advantageous if the item to be coated can be heated to a temperature which is favourable to the coating by a tempera-ture-control means, in particular by a heating means, associated with the receiving means. In addition or alternatively, it can be provided that the coating conveying means and/or the discharge means is allocated a temperature-control means which can keep a temperature of the coating within a predeterminable temperature range so that a stable thread of coating can be discharged from the discharge nozzle. This is particularly significant when a rotational movement of the item to be coated about the rotational axis is carried out at a high angular velocity in order not to have to take into account a break-off of the thread of coating due to aerodynamic effects, as a result of which the outer surface of the item to be coated would be coated in a relatively uneven manner.

It is expedient if the discharge means is arranged as a pro-cessing station on a machine frame and if a plurality of movably mounted receiving means which are configured for a particularly discontinuous transportation of items to be coated between the processing stations along a movement path, which is particularly in the form of a segment of a circle, are arranged to the machine frame. The machine frame is preferably an engine frame of a printing machine on which a plurality of processing stations is provided for proc-essing the item to be coated. In this respect, the processing stations also comprise the discharge means provided for coating the item to be coated, as well as additional means and/or arrangements which are configured for printing the item to be coated and/or for preparing the item to be coated for the coating procedure and/or for further processing the coated item after the coating pro-cedure. Provided for transporting the items to be coated be-tween the respective processing stations is a plurality of receiving means which are arranged in particular on a common workpiece rotary table which is mounted in a rotationally movable manner and is provided with a rotary drive. It is preferably provided that the rotary drive performs a discon-tinuous movement, in particular a rotational step movement of the workpiece rotary table and thereby of the receiving means. It is thereby possible for the receiving means and for the items to be coated, which have been respectively received on the receiving means, to be moved along a circle segment-shaped movement path between the individual processing stations which are preferably arranged in an identical angular spacing and at an identical radial distance with respect to a rotational axis of the rotary drive. The rotary drive can be, for example an electrical direct drive with a stator attached in a stationary manner to the machine frame and a rotor which is mounted in a rotationally movable manner with respect to the stator and is in particular integrated into the workpiece rotary table and which performs the desired rotational movement about a preferably vertically oriented rotational axis by being charged with electrical energy. The receiving devices are preferably configured as mandrels onto which the sleeve-shaped items to be coated can be placed. Alternatively, the receiving means can also be configured as chucks into which the items to be coated can be inserted, area by area, and then clamped.

In a further embodiment of the invention, it is provided that the discharge means is arranged along the movement path downstream of a printing device which is configured in particular as an ink-jet printing device and is configured to at least partly print the outer surface of the item to be coated before the coating procedure is carried out. The printing device can be configured, for example to carry out a contacting, indirect high pressure method with the aid of printing plates or to carry out a contactless ink-jet printing method which can also be called a digital printing method and in which a distribution of printing inks can be established individually for each item to be coated.

It is advantageous if the processing stations and the receiving means are accommodated in a spatial volume which is bordered by boundary walls and is separated from a surroundings and in which a constant room temperature and/or a predeterminable excess pressure compared to the surroundings is present. This can ensure reproducible conditions for the printing procedure. In addition to a control of the room temperature and/or of the predeterminable excess pressure, it is also possible to influence a gas composition prevailing in the spatial volume and/or to influence a moisture content, present in the spatial volume, in the typically gaseous atmosphere in the spatial volume.

The object of the invention is achieved for a method for decorating an outer surface of an item to be coated by the following steps: an at least partial printing of the outer surface of an item to be coated using a first discharge means in a printing procedure configured in particular as an ink-jet printing method, a pressurised supply of a coating from a coating conveying means to a discharge nozzle of a second discharge means and a discharge of the coating though the discharge nozzle onto the item to be coated, and during the printing procedure and/or during the coating procedure, a relative movement between at least one discharge means and the item to be coated is performed by a receiving means for the item to be coated, the relative movement comprising at least one rotation of the item to be coated about a rota-tional axis with respect to the discharge means.

In an advantageous development of the method, it is provided that the relative movement comprises a linear movement between the item to be coated and the discharge nozzle along the rotational axis.

In a further embodiment of the method, it is provided that linear movements of a plurality of discharge means are coordinated such that threads of coating from different discharge means are deposited in a crossed manner on the outer surface of the item to be coated, thereby achieving an advantageous wetting of the outer surface of the item to be coated with the applied coating.

In a further embodiment of the method, it is provided that a valve device is arranged to at least one discharge nozzle, which performs a dynamic establishment and disconnection of a fluidically communicating connection between coating conveying means and discharge nozzle, in particular to adapt to different product lengths of the item to be coated.

### BRIEF DESCRIPTION OF THE DRAWINGS

An advantageous embodiment of the invention is shown in the drawings, in which:

FIG. 1 is a schematic plan view of a printing machine with a rotatably mounted workpiece rotary table and a plurality of work stations for printing and inspecting cylindrical items,

FIG. 2 is a schematic front view of a work station, configured as a printing station, of the printing machine,

FIG. 3 is a schematic front view of a work station, configured as a coating station, of the printing machine,

FIG. 4 is a schematic plan view of the coating station according to FIG. 3,

FIG. 5 is a schematic sectional view of a discharge means which is configured to provide threads of coating, and

FIG. 6 is an end-face view of the discharge means according to FIG. 5.

### DETAILED DESCRIPTION

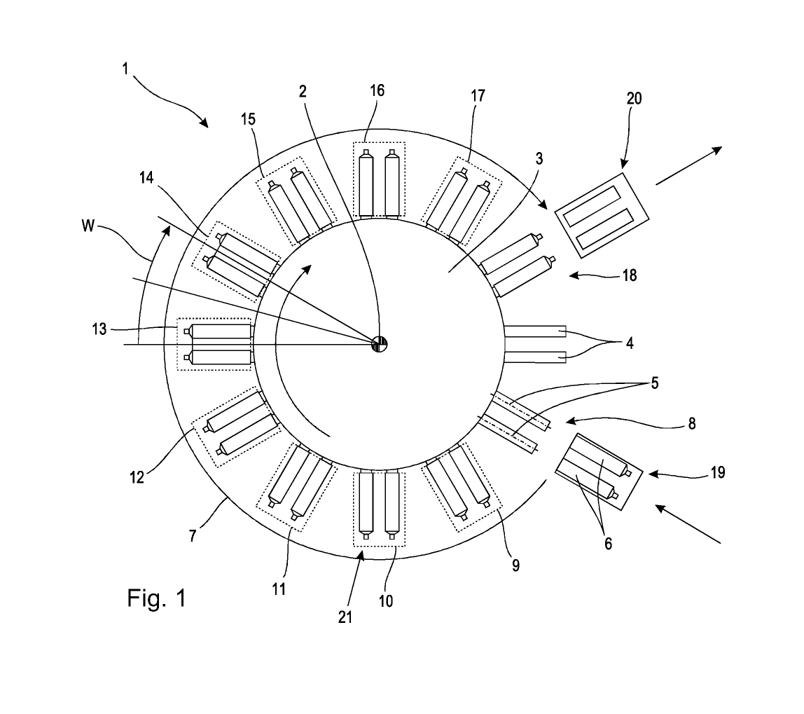

A printing machine 1 shown schematically in FIG. 1 comprises a workpiece rotary table 3 which is mounted on a machine frame (not shown) such that it can rotate about a rotational axis 2, and a plurality of workpiece mounts 4 which serve as receiving means and are respectively fitted, for example, in pairs on the workpiece rotary table 3. The workpiece mounts 4 are mounted with drive means (not shown) such that they can rotate individually about rotational axes 5. The workpiece mounts 4 are provided to receive sleeve-shaped items 6 which are configured in particular as aerosol can blanks or tube blanks and are at least substantially formed with a circular cylindrical cross section. The workpiece mounts 4 are preferably configured as mandrels, onto which can be attached the items 6 which are configured as hollow bodies, in particular as unilaterally closed hollow cylinders and are also called the items to be coated. By way of example, it is assumed that each of the workpiece mounts 4 is allocated its own drive motor (not shown) which can be electrically controlled separately and which allows the respective workpiece mount 4 to rotate about the respective rotational axis. 5. This possibility of a particularly controlled rotation of the respective workpiece mount 4 is used in particular during implementation of the printing procedure and of the coating procedure which is described in more detail in the following.

A plurality of work stations 8 to 18 which are configured to process and/or check the transported items 6 is arranged in an annular portion-shaped region which is swept over by the workpiece mounts 4 during a rotational movement of the workpiece rotary table 3 about the rotational axis 2 and which can be called the movement path 7 and which extends in the circumferential direction around the workpiece rotary table 3. Since the view according to FIG. 1 is a plan view and the work stations 9 to 17 are usually arranged vertically above the workpiece mounts 4, the work stations 9 to 17 are merely shown in dashed lines. The function and arrangement of the work stations 8 to 18 which are described in more detail in the following can be freely selected, subject to the provided processing sequence for the items 6; work stations with different functions can also be provided or they can be completely omitted.

Work station 8 is a loading station which is also called a feed station and at which the cylindrical items 6 are pushed, for example in pairs, onto the workpiece mounts 4 by a suitable transportation means 19 which is coupled to a conveying system (not shown) for the cylindrical items 6.

Purely by way of example, provided at work station 9 is a neutralisation of electrical charges which may be present on an outer surface 25 of the item 6. A neutralisation of this type is particularly advantageous in the case of plastics items 6 and can optionally be omitted for metal items 6. For the electrical (electrostatic) neutralisation of the items 6, work station 9 comprises a neutralisation arrangement (not shown) which can electrically discharge the item 6. For example, the neutralisation arrangement comprises two mutually spaced-apart electrodes to which an electrical alternating field is respectively applied by a control means (also not shown). In this respect, an electrical voltage and a frequency of the electrical alternating field are coordinated with the spacing of the electrodes such that gas, in particular air which is present in the surroundings of the electrodes can be ionised. By means of the ions which are released, a charge equalisation can take place with the electrical charges which are present on the outer surface 25 of the item 6. The item 6 which is now electrically neutral is then conveyed along the movement path 7 to the following work station 10.

Provided downstream along the movement path 7, following work station 9 is work station 10 which, purely by way of example, is a cleaning arrangement. For example, the cleaning station is configured as a suction means which is configured to suction, without contact, the outer surface 25 of the item 6.

At work station 11 which is arranged downstream along the movement path 7 after work station 10, purely by way of example the cylindrical items 6 are scanned optically to determine a rotatory position of the cylindrical items 6, for example to ensure a correct rotatory orientation of the cylindrical items 6 for a printing procedure which takes place at work station 12. This is particularly significant if the outer surface to be printed of the items 6 is provided with features which are to match, in a predetermined manner, the printed image which is to be applied. These features can be, for example, local imprints and/or stampings (embossing) in and/or out of the outer surface of the item 6, and/or preprinted regions which, for their part, are to serve as the foundation for the subsequent printing.

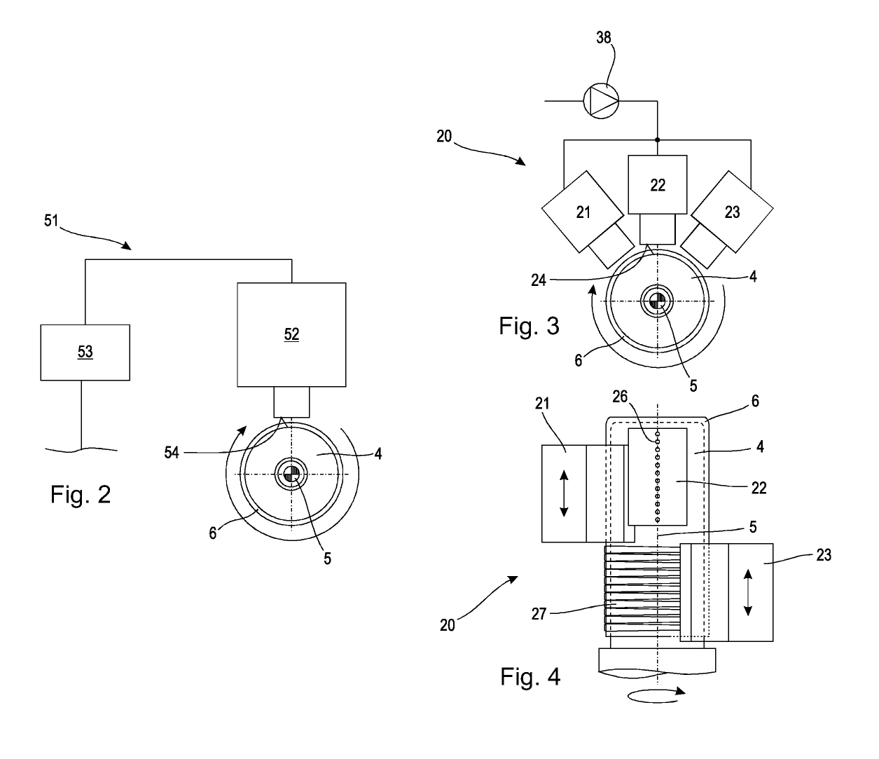

In the course of a further rotational step movement of the workpiece rotary table 3 about the rotational axis 2, item 6 is then moved successively to work stations 12, 13 and 14 which are each configured, purely by way of example, as printing stations, to there be respectively printed by printing devices 51, as shown by way of example in FIG. 2. During the printing procedure, it is provided that the item 6, configured for example with a circular cylindrical cross section performs a rotational movement about the rotational axis 5, shown in FIG. 1, and during the rotational movement, it can be printed by a print head 52 which is shown schematically in FIG. 2 and which is, for example, an ink-jet print head. During the printing procedure, drops of colour (not shown) are discharged from the print head 52 which is arranged for example at a distance of 1 mm to 5 mm from the outer surface of the item 6 and is controlled by electrical signals from a print control means 53. The discharge nozzles (also not shown) of the print head 52 which open on a discharge surface 54 are preferably oriented such that the drops of colour are discharged at least almost vertically to the outer surface 25 of the item 6.

Work station 15 which is arranged downstream of work station 14 along the movement path 7 is configured, for example as an inspection means and allows the print quality to be determined of the printed image which has been applied to the circumferential surface of the item 6 by the print station 21.

The further work station 16 is used for the further processing of the cylindrical item 6 by applying a protective coat to the printing at least over partial surfaces of the item 6 which will be described in more detail in the following in connection with FIGS. 3 to 6.

An unloading procedure takes place at work station 18, during which the cylindrical items 6 are removed from the mandrel-type workpiece mounts 4 by a transportation means 20 and are delivered to a further conveying transportation system (not shown).

The workpiece rotary table 4 performs a rotational step movement about angle W for the stepwise processing of the cylindrical items 6 at the respective works stations 8 to 18, in which rotational step movement the workpiece mounts 4 which are respectively arranged in pairs are transported form a position opposite the respective work station 8 to 18 into a position opposite the respectively following work station 8 to 18. In this respect, the rotary step movement takes place as a sequence of an acceleration from standstill, a braking from the target speed which has been reached and a subsequent standstill time. A drive (not shown) for the workpiece rotary table 3 is preferably configured such that the acceleration and braking of the workpiece rotary table 3 can be set within wide ranges and the standstill time can be set completely freely and can be adapted to the processing requirements of the respective cylindrical items 6 at the work stations 8 to 18.

The coating means 20 shown in detail in FIGS. 3 to 6 is configured to apply a coating, in particular a clear coating to the outer surface 25 of the item to be coated and comprises for example three discharge means 21, 22, 23 which are configured similarly in each case and which, according to the view of FIG. 3, are arranged circularly in respect of the rotational axis 5 of the receiving means 4. As can be seen in the view of FIG. 4, the discharge means 21, 22, 23 are arranged in different positions along the rotational axis 2 of the receiving means 4. By way of example, it is assumed that the discharge means 21, 22, 23 can be moved parallel to the rotational axis 2 by adjusting means (not shown), as is represented by the respective movement arrows.

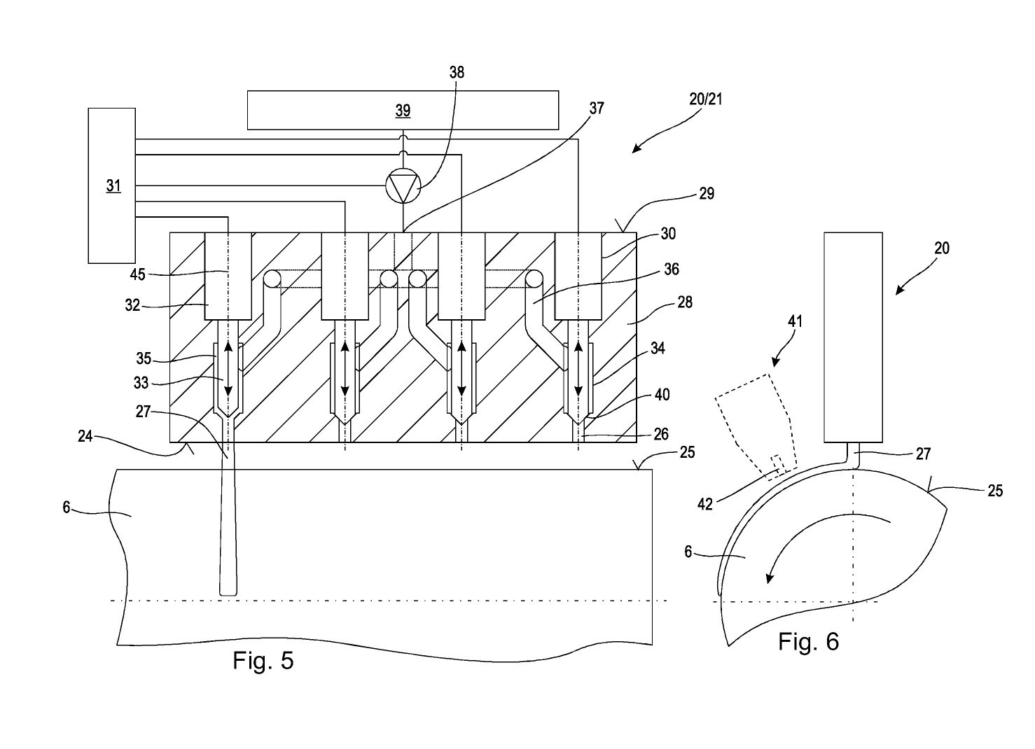

The discharge means 21, 22, 23 are each configured similarly, the construction method of which is shown in more detail in FIG. 5 and is described in the following. Each of the discharge means 21, 22, 23 has for example a row of discharge nozzles 26 on a discharge surface 24. For example, the discharge nozzles 26 are arranged in an equal spacing along a straight line which is oriented in particular parallel to the rotational axis 5, positions of the discharge nozzles 26 on the discharge means 22 being shown schematically by circles in FIG. 4. As can also be seen from FIG. 4, the discharge means 21, 22, 23 are configured to provide threads of coating on the outer surface 25 of the item 6. For example, according to the view of FIG. 4, during a rotation of the item 6 about the rotational axis 5, only discharge means 23 discharges threads of coating 27, while the discharge means 21 and 22 are, for example, deactivated at this time. In this respect, a radial distance of the discharge means 21, 22 and 23 from the item 6, an orientation of the discharge means 21, 22 and 23 with respect to the item 6 and a circumferential speed of the item 6 are adapted to the flow characteristics of the coating to be processed such that a thread of coating 27, shown schematically in each of FIGS. 4, 5 and 6, is applied continuously to the outer surface 24 of the item 6. In this respect, a diameter and a flow rate of the thread of coating 27 is selected such that upon impact on the item 6, a closed coating surface can be achieved on the outer surface 24 of the item 6 due to the flow characteristics of the coating.

As can be seen from the view of FIG. 5, the discharge means 21 which is shown in detail by way of example and is greatly simplified for reasons of clarity comprises a basic body 28 which is produced from a dimensionally stable material, for example from a metallic material. Introduced into the basic body 28 which is plate-shaped, for example, are discharge nozzles 26, the nozzle axes 45 of which are oriented, for example normally to the discharge surface 24. From a mounting surface 29 opposite the discharge surface 24, receiving holes 30 for magnetic drives 32 have been made in the basic body 28. For example, the magnetic drives 32 are configured as magnetic coil drives with a circular cylindrical shape and they are fully accommodated in the basic body 28. Each of the magnetic drives 32 comprises a nozzle needle 33 which is mounted in a linearly movable manner and passes through the basic body 28 from the magnetic drive 32 and protrudes into a valve chamber 34. The valve chamber 34 has a greater diameter than the nozzle needle 33 so that an annular chamber 35 is formed between the nozzle needle 33 and the valve body 34. Opening in the annular chamber 35 is a supply channel 36 which is in a fluidically communicating connection with a supply connection 37. Connected to the supply connection 37 is a coating conveying means 38 which is configured, for example as a coating pump and for its part is coupled in a fluidically communicating manner to a reservoir 39. Furthermore, the coating conveying means 38 is electrically connected to a coating control means 31 which is configured to provide electrical energy to the coating conveying means 38 to initiate a conveying of coating out of the reservoir 39 to the discharge nozzles 26. The magnetic drives 32 are also connected electrically to the coating control means 31 and can be selectively controlled thereby in order to either clear or block a valve seat 40, provided at the transition between valve body 34 and discharge nozzle 26, by means of the respective nozzle needle 33. As a result, a fluidically communicating connection between the reservoir 39 via the supply connection 37 and the supply channel 36 and the annular chamber 35 to the discharge nozzle 26 can be blocked or cleared. Purely by way of example, according to the view of FIG. 5, only one discharge nozzle 26 is cleared by the associated nozzle needle 33 so that only there can a thread of coating 27 be discharged which can be deposited on the outer surface 24 of the item 6 which is arranged opposite and is rotated about the rotational axis 5.

As can be gathered from the views of FIGS. 5 and 6, the thread of coating 27 is conveyed only by hydrostatic pressure on the coating which is removed from the reservoir 39 by means of the coating conveying means 38. For reasons of clarity, the illustration of the thread of coating 27 has not been selected as being true to scale, in practice, a much thinner configuration of the discharge nozzle 26 and of the thread of coating 27 resulting therefrom is to be provided.

As can be learnt from the dashed illustration in FIG. 6, it is possible to arrange, in the direction of rotation, mounted downstream of the discharge means 21 an optional air nozzle 41 which has a slotted air outlet 42 which extends by its greatest extent along the rotational axis 2. By means of the air nozzle 41, an air jet is discharged vertically onto the outer surface 25 of the item 6 to overcome a surface tension of the thread of coating 27 applied to the outer surface 25, so that the thread of coating 27 is distributed as widely as possible over the outer surface 25, thereby allowing an advantageous distribution of the coating.

By way of example it is provided that the coating control means 31 and the print control means 53 are electrically interconnected, in particular as bus subscribers and are controlled in a coordinated manner by a superior control means, in particular by a memory-programmable control (SPS) (not shown).

1. A coating device for coating an outer surface of an item to be coated, having a discharge means for providing a continuous or discontinuous flow of coating and having a receiving means for receiving and positioning an item to be coated opposite the discharge means, wherein the discharge means comprises a discharge nozzle and a coating conveying means which is connected in a fluidically communicating manner to the discharge nozzle and is configured for a pressurised conveying of coating to the discharge nozzle, wherein the coating conveying means is configured to provide a hydrostatic pressure on the coating and wherein the discharge nozzles are configured to discharge threads of coating subject to the hydrostatic pressure on the coating.

2. The coating device according to claim 1, wherein the receiving means is configured to rotationally mount the item to be coated about a rotational axis which is oriented transversely to a nozzle axis which determines a coating discharge direction from the discharge nozzle.

3. The coating device according to claim 1, wherein the discharge means is arranged such that it is linearly movable with respect to the receiving means and comprises an adjusting means which can be controlled open loop or closed loop for a linear movement along the rotational axis.

4. The coating device according to claim 1, wherein a plurality of discharge means are arranged in a circulatory manner with respect to the rotational axis.

5. The coating device according to claim 1, wherein the discharge means comprises a plurality of discharge nozzles which are preferably arranged in an identical spacing.

6. The coating device according to claim 1, wherein a valve device for a temporary interruption in the fluidically communicating connection is arranged between the coating conveying means and the discharge nozzle.

7. The coating device according to claim 1, wherein the coating conveying means and/or the discharge means and/or the receiving means is allocated a temperature-control means to control the temperature of the coating and/or of the item to be coated.

8. The coating device according to claim 1, wherein the discharge means is arranged as a processing station on a machine frame and wherein a plurality of movably mounted receiving means which are configured to transport items to be coated between the processing stations along a movement path are arranged at the machine frame.

9. The coating device according to claim 8, wherein the discharge means is arranged along the movement path downstream of a printing device which is configured in particular as an ink-jet printing device and is configured to at least partly print the outer surface of the item to be coated before the coating procedure is carried out.

10. The printing device according to claim 9, wherein the processing stations and the receiving means are accommodated in a spatial volume which is bordered by boundary walls and is separated from a surroundings and in which a constant room temperature and/or a predeterminable excess pressure compared to the surroundings is present.

11. A method for decorating an outer surface of an item to be coated comprising the steps: the at least partial printing of the outer surface of the item to be coated using a first discharge means in a printing procedure configured as an ink-jet printing method, a pressurised supply of a coating from a coating conveying means to a discharge nozzle of a second discharge means and the discharge of the coating through the discharge nozzle onto the item to be coated, and during the printing procedure and/or during the coating procedure, a relative movement between at least one discharge means and the item to be coated is performed by a receiving means for the item to be coated, the relative movement comprising at least one rotation of the item to be coated about a rotational axis with respect to the discharge means.

12. The method according to claim 11, wherein the relative movement comprises a linear movement between the item to be coated and the discharge nozzle along the rotational axis.

13. The method according to claim 11, wherein linear movements of a plurality of discharge means are coordinated such that threads of coating from the different discharge means are deposited in a crossed manner on the outer surface of the item to be coated, thereby achieving an advantageous wetting of the outer surface of the item to be coated with the applied coating.

14. The method according to claim 11, wherein a valve device is allocated to at least one discharge nozzle which performs a dynamic establishment and disconnection of a fluidically communicating connection between coating conveying means and discharge nozzle, to adapt to different product lengths of the item to be coated.

15. A coating device for coating an outer surface of an item to be coated, comprising:
a discharge assembly for providing a continuous or discontinuous flow of coating, the discharge means comprising:
a discharge nozzle; and
a coating conveying means which is connected in a fluidically communicating manner to the discharge nozzle and is configured for a pressurized conveying of coating to the discharge nozzle, wherein the coating conveying means is configured to provide a hydrostatic pressure on the coating and wherein the discharge nozzles are configured to discharge threads of coating subject to the hydrostatic pressure on the coating; and
a receiving means for receiving and positioning the item to be coated opposite the discharge means.
